(19) United States
(12) Patent Application Publication
(10) Pub. No.: US 2018/0249717 A1
(43) Pub. Date: Sep. 6, 2018

(54) HOUSE DUST MITE ALLERGY PROTEIN REMOVER, AND COMPOSITION THEREOF

(71) Applicant: AYJ BIO LAB INC., Seoul (KR)

(72) Inventors: Young-Yull KOH, Seoul (KR); Gwang-Joo JEON, Seoul (KR); Hyun-Kyung KIM, Daejeon (KR); Haribalan PERUMALSAMY, Seoul (KR); Karuppasamy SANKARAPANDIAN, Seoul (KR); Young-Joon AHN, Seoul (KR)

(21) Appl. No.: 15/760,038

(22) PCT Filed: Sep. 21, 2015
(86) PCT No.: PCT/KR2015/009781

§ 371 Date: Mar. 14, 2018

(30) Foreign Application Priority Data
Sep. 18, 2015 (KR) 10-2015-0132059

(51) Int. Cl. A01N 65/22; A01N 65/10; A01N 65/28; A01N 65/36

(52) U.S. Cl. CPC A01N 65/22; A01N 65/36; A01N 65/28; A01N 65/10

(57) ABSTRACT

The present invention relates to an agent for removing house dust mite allergens and a composition comprising the same. The composition comprises, as an active ingredient, the agent which is composed of a natural plant essential oil or its steam distillate and can effectively remove allergens derived from house dust mites. Thus, the agent and the composition can be used for the prevention, alleviation, mitigation or treatment of various allergic diseases, which can be caused by allergens derived from house dust mites, in an environmentally friendly and efficient manner without causing particular side effects. In addition, the agent and the composition can significantly reduce the prevalence of diseases caused by house dust mites and the frequency of exposure of people to house dust mites.

### BACKGROUND OF THE INVENTION

### Field of the Invention

The present invention relates to an inactivator for house dust mite allergen proteins and a composition comprising the same, and more particularly, to an inactivator for house dust mite allergen proteins, which can effectively inactivate various allergen proteins, derived from house dust mites, by denaturation or neutralization, and, at the same time, has acaricidal activity against house dust mites, the inactivator being composed of natural plant essential oil or its steam distillate, and to a composition for inactivating house dust mite allergen proteins or killing house dust mites, which comprises the inactivator for denaturating or neutralizing house dust mite allergen proteins.

### Description of the Prior Art

The prevalence and severity of allergic diseases such as asthma, atopic dermatitis, and perennial rhinitis caused by house dust mites, are among the most serious global public health problems [Arlian, L. G. 2002. Arthropod allergens and human health. Annu. Rev. Entomol. 47, 395433; Bessor, J. C. & G. Pauli. 2011. Mite allergens: an overview. Eur. Ann. Allergy Clin. Immunol. 43: 141156.]. House dust mites are the most common cause of allergic symptoms in humans, and affect 65 million to 1.2 billion people worldwide [Colloff, M. J. 2009. Dust Mites. Springer, Dordrecht.]. House dust mites are frequently found in areas such as mattresses, furniture and carpets, in which people frequently live and horny substances or dandruff accumulates. The American house dust mite, Dermatophagoides farinae, and the European house dust mite, Dermatophagoides pteronyssinus, are two of the most important pyroglyphid mites and are recognized as an important source of allergens in certain occupational environments and in the domestic environment [Bessor, J. C. & G. Pauli. 2011. Mite allergens: an overview. Eur. Ann. Allergy Clin. Immunol. 43: 141156.]. These allergens are produced in the gastrointestinal tract of house dust mites and excreted with feces.

Of allergic diseases caused by house dust mites, asthma is the most important disease because of high morbidity and mortality of asthma patients [Mart, H. Q. & N. Ferguson. 2009. Life-threatening asthma: focus on lung protection. Intensive Care Medicine, Springer. pp. 372382]. Approximately 5-10% of all adults and 10-20% of all children worldwide suffer from asthma [UK BIVDA. 2002. Diagnostics in Healthcare. The British In Vitro Diagnostics Association.]. Worldwide, the reported mortality rate from an exacerbation of asthma that requires intubation varies from 1.50 to 86.92 deaths per million population (average of 22.0 deaths) [Martinez, H. Q. & N. Ferguson. 2009. Life-threatening asthma: focus on lung protection. Intensive Care Medicine. Springer, pp. 372-382]. Most house dust mite allergens are proteins with a molecular weight range of 14-60 kDa [Thomas, W. R., W. A. Smith, B. J. Hales, K. L. Mills & R. M. O'Brien. 2002. Characterization and immunobiology of house dust mite allergens. Int. Arch. Allergy Immunol. 129: 118]. Of 21 denominated house dust mite allergens, most allergic patients showed over 90% adverse reactions to group I and II allergens, two major house dust mite allergens [Arlian, L. G. & T. A. E. Platts-Mills. 2001. The biology of dust mites and the remediation of mite allergens in allergic disease. J. Allergy Clin. Immunol. 107: S406S413; Thomas, W. R., W. A. Smith, B. J. Hales, K. L. Mills & R. M. O'Brien. 2002. Characterization and immunobiology of house dust mite allergens. Int. Arch. Allergy Immunol. 129: 118].

The number of house dust mites is proportional to the amount of house dust mite allergens, and the risk of diseases caused by these house dust mites also increases in proportional to the amount of house dust mite allergens. In the case of group I allergens, 1 g of allergens correspond to about 50 house dust mites. 2 g of allergens can cause sensitization, and 10 g or more of allergens can cause a seizure. Thus, 2-10 g of house dust mite allergens are considered a risk factor of asthma, and correspond to about 100-500 house dust mites per gram of house dust (Platts-Mills, T. A. E & M. D. Chapman. 1987. Dust mites; Immunology, allergic diseases, and environmental control. J. Allergy Clin. Immunol. 80: 755757; Korsgaard, J. 1983. Mite asthma and residency; a case-control study on the impact of exposure to house dust mites in dwellings. Am. Rev. Respir. Dis. 128, 231235; Platts-Mills, T. A. E. et al. 1989. Dust mite allergen and asthma-A worldwide problem. J. Allergy Clin. Immunol. 83: 416427). In Korea, it was reported that the number of mites in the dust collected from bed clothes, cloth sofas and carpets was proportional to the allergenic content of the mites and that 2 g or more of allergens were detected in 31.2% of the examined homes and 10 or more of allergens were also detected in 10% or more of the examined homes (Chun-Soo Hong and Mi-Kyung Lee, 1990, Examination of Group I Allergen Content of House Dust Mites in House Dust, Allergy 10: 347348), indicating that many people are exposed to the risk of diseases caused by house dust mites.

Control of house dust mites has been principally provided by the use of synthetic chemicals, such as γ-BHC, pirimiphos-methyl, benzyl benzoate, diethyl-m-toluamide (DEET), dibutyl phthalate, and pyrethroids.1,2,6 (Pollart, S. M., G. W. Ward, Jr. & T. A. E. Platts-Mills. 1987. House dust sensitivity and environmental control. Immunol. Allergy Clin. North Am. 7: 447461; Platts-Mills, T. A. E., W. R. Thomas, R. C. Aalberse, D. Vervloet & M. D. Chapman MD. 1992. Dust mite allergens and asthma: report of a second international workshop. J. Allergy Clin. Immunol. 89: 10461062). House dust mite allergens are associated with feces, salivary secretions, whole body particles, debris of cuticles, and cells [Toney, E. R., M. D. Chapman, & T. A. E. Platts-Mills. 1981. Mite faeces are a major source of house dust allergens. Nature 289: 592593; Arlian, L. G. & T. A. E. Platts-Mills. 2001. The biology of dust mites and the remediation of mite allergens in allergic disease. J. Allergy Clin. Immunol. 107: S406S413]. Dead mites and mite fecal pellets containing allergens persist months after eradication of live mites [Green, W. F. 1984. Abolition of allergens by tannic acid. Lancet 324: 160]. In addition, the house dust mites contain potent digestive enzymes that persist in their feces and are major inducers of allergic reactions [Schultz, N. D., A. V. Giannini, T. T. Chang & D. C. Wong. 1994. Insect Allergy. In The Best Guide to Allergy. 3rd edition. Springer Science+Musiness Media: New York, pp. 137-148]. Thus, even when house dust mites are controlled with acaricides, it is difficult to prevent allergic diseases from occurring, as long as the dead bodies of house dust mites persist.

Tannic acid is a currently available protein denaturing agent since it was first recommended for reducing the allergenicity of house dust [Green, W. F. 1984. Abolition of allergens by tannic acid. Lancet 324: 160]. This compound is used to denature mite allergens, which results in reducing the allergenicity of house dust [Woodfolk, J. A., M. L. Hayden, J. D. Miller, G. Rose, M. D. Chapman & T. A. E. Platts-Mills. 1994. Chemical treatment of carpets to reduce allergen: a detailed study of the effects of tannic acid on indoor allergens. J. Allergy Clin. Immunol. 94: 1926]. The denaturing action of tannic acid is not protein specific. One or 3% tannic acid solution (wt/vol) are commercially available in the United States. A 3% tannic acid solution (wt/vol) denatures group 1 allergens (Der p I and Der f I) but is somewhat less effective for group 2 allergens (Der p II and Der f II) [Ehnert, B., S. Lau-Schadendorf, A. Weber, P. Buettner, C. Schou & U. Wahn. 1992. Reducing domestic exposure to dust mite allergen reduces bronchial hypersensitivity in sensitive children with asthma. J. Allergy Clin. Immunol. 90: 135138]. In a site with a high content of house dust mite allergens, chemical treatment of carpets and mattresses is insufficient to produce a sustained beneficial reduction in mite allergen levels as a result of widespread existence of house dust mites in the environment [Visitsunthorn, N., V. Chirdjirapong, V. Pootong, O. Jirapongsananuruk, P. Pacharn, S. Weeravejsukit, V. Mahakittikun & P. Vichyanond. 2010. The accumulation of dust mite allergens on mattresses made of different kinds of materials. Asian Pac. J. Allergy Immunol. 28: 155161]. In addition, tannic acid stains fabrics in a practical application and there is also residual tannic acid in carpet dust [Woodfolk, J. A., M. L. Hayden, N. Couture & T. A. E. Platts-Mills. 1995. Chemical treatment of carpets to reduce allergen: comparison of the effects of tannic acid and other treatments on proteins derived from dust mites and cats. J. Allergy Clin. Immunol. 96: 325333]. However, other effective compounds or compositions capable of substituting for tannic acid have not yet been developed.

Typical prior art documents related to agents for killing hose dust mites or inactivating hose dust mite allergens, which comprise plant extracts or plant essential oils, are as follows.

Korean Patent Laid-Open Publication No. 10-2003-0015822 (published on Feb. 25, 2003) discloses an acaricidal composition comprising an essential oil extracted from one or more plants selected from the group consisting of Melaleuca leucadendron, Pseudotsuga menziesii, Ferula galbaniflua, Pelargonium ordoratissimum, Pelargonium radens, Pelargonium capitatum, Helichrysum augustifolium, Andropogon muricatus, Lavendula officinalis, Origanum majorana, Milissa officinalis, Melaleuca viridiflora, Ravensara aromatica, Sassafras albudum, Tagetes erecta, Tagetes patula, and Verbena officinalis. It also discloses an acaricidal composition comprising one or more monoterpene compounds selected from the group consisting of geraniol, linalool, (−)-cis-myrtanol, trans-myrtanol, (−)-myrtenal, (−)-myrtenol, thujone, cis-verbenol, (−)-verbenone, menthone, and indoline.

However, the above prior art document is directed merely to the acaricidal composition, and does not mention inactivation of house dust mite allergen proteins.

In addition, Korean Patent Laid-Open Publication No. 10-2005-0084666 (published on Aug. 26, 2005) discloses a method and composition for neutralizing dust mite feces, the method comprising bringing dust mite feces into contact with an aqueous solution of a water-soluble plant extract selected from the group consisting of Apple Green Tea, Arkin Special, Arnica Special, Avocado, Avocado GW, Black Currant Green Tea, Cabbage Rose, Cat's Claw, Cemila Oleifera, Centella, Cranberry Green Tea, Dandelion, Garcinia, Grape Seed, Grapefruit Green Tea, Green Tea, Green Tea Concentrate, Green Tea HS, Hexaplant Richter, Hibiscus Special, Hydrocotyle GR, Lavender, Horse Chestnut, Milk Thistle, Orange Green Tea, Phytexcell Arnica, Purple Coneflower, Sage GW, Sage Special, Sedaplant Richter, St. John's Wort, Witchhazel GW, Yarrow, and combinations thereof.

However, the above prior art document merely mentions neutralization of dust mite feces that are allergens, and mention neither killing of house dust mites, nor allergens such as house dust mites or their dead bodies or part of the dead bodies.

### PRIOR ART DOCUMENTS

### Patent Documents

Patent Document 1: Korean Patent Laid-Open Publication No. 10-2003-0015822 (published on Feb. 25, 2003);

Patent Document 2: Korean Patent Laid-Open Publication No. 10-2005-0084666 (published on Aug. 26, 2005).

### SUMMARY OF THE INVENTION

Therefore, it is an object of the present to provide an inactivator for house dust mite allergen proteins comprising a plant essential oil or its steam distillate, which has strong acaricidal activity against house dust mites and, at the same time, shows a strong ability to inactivate allergen proteins, produced by house dust mites, by effectively denaturating or neutralizing these allergen proteins.

Another object of the present invention is to provide an effective composition for removing house dust mites, which contains, as an active ingredient, the above inactivator for denaturating or neutralizing house dust mite allergen proteins.

Still another object of the present invention is to provide an effective composition for killing house dust mites, which contains, as an active ingredient, the above inactivator for denaturating or neutralizing house dust mite allergen proteins.

To achieve the above objects, in accordance with one aspect of the present invention, there is provided an inactivator for house dust mite allergen proteins, which has an ability to denature or neutralize house dust mite allergen proteins, the inactivator being composed of either at least one compound selected from the group consisting of allyl isothiocyanate, anethole, beta-asarone, camphor, delta-3-carene, citronellol, cumene, cuminaldehyde, geranial, isopulegol, lavandulol, linalool oxide, myristicin, neral, nerol, nerolidol, perillaldehyde, perilla alcohol, and thymol.

In accordance with another aspect of the present invention, there is provided an inactivator for house dust mite allergen proteins, which has an ability to denature or neutralize house dust mite allergen proteins, the inactivator being composed of either an essential oil or a steam distillate from at least one plant selected from the group consisting of basil (Ocimum basilicum), cade (Juniperus oxycedrus), caraway (Carum carvi), carrot seed (Daucus carota), catnip (Nepeta cataria), celery (Apium graveolens), coriander herb (Coriandrum sativum), cypress (Cupressus sempervirens), lemon eucalyptus (Eucalyptus citriodora), garlic (Allium sativum), juniperberry (Juniperus communis), lime (Citrus aurantifolia), mandarin (Citrus reticulata), oregano (Origanum vulgare), palmarosa (Cymbopogon martinii), pennyroyal (Mentha pulegium), pine (Pinus sylvestris), Dalmatian sage (Salvia officinalis), spearmint (Mentha spicata), and summer savory (Satureja hortensis).

Herein, the inactivator for house dust mite allergen proteins may be composed of a mixture of the essential oil and the steam distillate.

In accordance with still another aspect of the present invention, there is provided a composition for inactivating house dust mite allergen proteins or killing house dust mites, the composition comprising an effective amount of the above inactivator for denaturating or neutralizing house dust mite allergen proteins.

The effective amount may be 0.1-50 wt %, particularly 0.1-10 wt %, based on the total weight of the composition.

In addition, the composition may further comprise at least one additive selected from among tannic acid, pesticides, acaricides, aromatics, and mixtures thereof.

Optionally, the composition may comprise ethanol as a solvent, polyoxyethylene+polyoxypropylene (9:1) styrenated phenyl ether as a surfactant, and distilled water.

Optionally, the composition may comprise polyoxyethylene lauryl ether, polysorbate 80, ethanol as a solvent, and distilled water.

In addition, the composition may be in the form of aerosol, spray, solution, suspension, powder, or capsule.

In accordance with still another aspect of the present invention, there is provided a carrier comprising the above-described inactivator for house dust mite allergen proteins.

### BRIEF DESCRIPTION OF THE DRAWINGS

FIG. 1 shows the results of SDS-PAGE electrophoresis of reaction products obtained by reactions between plant essential oils and house dust mite proteins, and shows a comparison between the pattern of known proteins and the pattern of proteins of the reaction products.

FIG. 2 shows the results of a dot-blot immunoassay performed to examine the human-specific IgE reactivity of plant essential oils.

### DETAILED DESCRIPTION OF THE INVENTION

The present invention is directed to an essential oil or an oil obtained by steam distillation from plant tissue (leaf, root, fruit, stem, etc.), which has acaricidal activity against house dust mites and, at the same time, has the ability to inactivate allergen proteins, produced by house dust mites, by denaturation or inactivation.

As used herein, the term “house dust mites” are intended to include all mites that are found in house dust. In Japan, 17-36 species of mites found in house dust were reported, and in Korea, 12-26 species of house dust mites have been reported to date since the first report by Joo et al. in 1967.

The inactivator for house dust mite allergen proteins according to the present invention has the ability to inactivate house dust mite allergen proteins by denaturation or inactivation and, at the same time, has acaricidal activity against house dust mites. This agent according to the present invention is composed of either at least one compound selected from the group consisting of allyl isothiocyanate, anethole, beta-asarone, camphor, delta-3-carene, citronellol, cumene, cuminaldehyde, geranial, isopulegol, lavandulol, linalool oxide, myristicin, neral, nerol, nerolidol, perillaldehyde, perilla alcohol, and thymol.

In another embodiment, the inactivator for dust mite allergen proteins according to the present invention has the ability to inacivate house dust mite allergen proteins by denaturation or neutralization and, at the same time, has acaricidal activity against house dust mites, and this inactivator may be composed of either an essential oil or a steam distillate from at least one plant selected from the group consisting of basil (Ocimum basilicum), cade (Juniperus oxycedrus), caraway (Carum carvi), carrot (Daucus carota), catnip (Nepeta cataria), celery (Apium graveolens), coriander herb (Coriandrum sativum), cypress (Cupressus sempervirens), lemon eucalyptus (Eucalyptus citriodora), garlic (Allium sativum), juniperberry (Juniperus communis), lime (Citrus aurantifolia), mandarin (Citrus reticulata), oregano (Origanum vulgare), palmarosa (Cymbopogon martinii), pennyroyal (Mentha pulegium), pine, (Pinus sylvestris), Dalmatian sage (Salvia officinalis), spearmint (Mentha spicata), and summer savory (Satureja hortensis).

The present invention also provides a composition for inactivating house dust mite allergen proteins, comprising an effective amount of the inactivator for removing house dust mites, which has acaricidal activity against house dust mites. As used herein, the term “effective amount” refers to an amount required to reduce the amount of mites to a level that does not cause allergy and to denature or neutralize allergen proteins. Preferably, the effective amount may be 0.1-50 wt % based on the total weight of the composition. Further, the composition of the present invention may comprise, in addition to the allergen proteins inactivator, an additive. The additive that may be used in the present invention may be one or more selected from the group consisting of tannic acid, pesticides, acaricides, and aromatics.

The present invention is directed to an essential oil or a steam distillate from plant tissue, which has the ability to inactivate allergen proteins, produced by Dermatophagoides farinae and Dermatophagoides pteronyssinus, which are the most predominant house dust mite species worldwide, and also has acaricidal activity against Dermatophagoides farinae and Dermatophagoides pteronyssinus.

The composition of the present invention may further comprise, in addition to the plant essential oil or its steam distillate, at least one additive selected from among conventional pesticides, acaricides, aromatics, industrial products, quasi-drugs, medical drugs, etc., which are frequently used at home. In this case, the plant essential oil or its steam distillate according to the present invention is contained in an amount of 0.1-50 wt % based on the total weight of composition of the present invention. It is to be understood that the content of the plant essential oil, the steam distillate or the additive in the composition may vary depending on various conditions, including the density of house dust mites, the formulation of the composition, a place to which the composition is to be applied, a method for application of the composition, etc.

The present invention is directed to a plant essential oil or a steam distillate from plant tissue, which has a strong ability to inactivate important allergens derived from house dust mites.

The compound of the present invention may further comprise, in addition to the plant essential oil or its steam distillate or any compound contained in the plant essential oil or steam distillate, tannic acid which is generally used as an agent for neutralizing house dust mite allergens. In this case, the plant essential oil, the steam distillate or the compound is preferably contained in an amount of 0.1-50 wt % based on the total weight of the composition of the present invention. In addition, the composition of the present invention may further comprise, in addition to the plant essential oil or the steam distillate or the compound, at least one additive selected from among conventional pesticides, acaricides, aromatics, industrial products, quasi-drugs, medical drugs, etc., which are frequently used at home. In this case, the plant essential oil or its steam distillate according to the present invention is contained in an amount of 0.1-10 wt % based on the total weight of the present invention. It is to be understood that the content of the plant essential oil, the steam distillate or the compound or the additive in the composition may vary depending on various conditions, including the amount of allergens produced by house dust mites, the formulation of the neutralizing agent, a place to which the composition is to be applied, a method for application of the composition, etc.

The present invention also provides a composition for inactivating house dust mite allergen proteins, which contains the compound alone or a mixture of two or more of the compounds.

The composition for killing house dust mites is used for the purpose of killing house dust mites, and may be formulated in the form of aerosol, spray, solution, suspension, powder, capsule, etc.

The inactivator is used for the purpose of denaturating or neutralizing house dust mite allergen proteins, and may be formulated in the form of aerosol, spray, solution, suspension, powder, capsule, etc.

The composition for inactivating house dust mite allergen proteins, which contains the above-described plant essential oil, steam distillate, compound or mixture, exhibits the effect of inactivating allergen proteins produced by Dermatophagoides farinae and Dermatophagoides pteronyssinus.

The most potent allergens that cause allergic diseases are divided mainly into group I having a molecular weight of 25 kDa and group II having a molecular weight of 14 kDa, which all show an incidence of 90% or more.

The present invention also provides a carrier comprising the above-described inactivator for denaturating or neutralizing house dust mite allergen proteins. Examples of such a carrier include, but are not limited to, wall paper, woven or nonwoven fabric, a coating layer on an interior finishing material, etc.

Hereinafter, the present invention will be described in further detail with reference to experimental examples. It is to be understood, however, that these examples are for illustrative purposes only and are not intended to limit the scope of the present invention.

In addition, the numbering of Examples of essential oils and their steam distillates will be omitted.

### EXPERIMENTAL EXAMPLE 1

### Acaricidal Activity against House Dust Mites

A vapor-phase mortality bioassay was used to evaluate the acaricidal effect of plant essential oils or steam distillates against adult American house dust mites (Dermatophagoides farina), as described previously [Yun, Y. K., H. K. Kim, J. R. Kim, K. Hwang & Y. J. Ahn. 2012. Contact and fumigant toxicity of Armoracia rusticana essential oil, allyl isothiocyanate and related compounds to Dermatophagoides farinae. Pest Manag. Sci. 68: 788794]. Groups of 40-50 adult mites (both sexes, 7-10 days old) were placed separately onto untreated cotton-fabric circles on the bottom section of polystyrene containers (5 cm diameter×2 cm), and each container was sealed with the original tight-fitting lid which had a fine wire screen covering a 3 cm diameter central hole. Appropriate amounts of the test materials in 100 μL of ethanol were applied to 5 cm diameter black cotton-fabric circles. Each treated fabric circle was placed on top of the wire screen, which prevented direct contact of adult mites with the test material. Each container was sealed with another solid lid to investigate the potential vapor-phase toxicity of the test materials. Control cotton-fabric circles received 100 μL of ethanol only. Mortalities were determined 24 h post-treatment under a dissecting microscope (×20). A mite was considered dead if its body and appendages did not move when prodded with a fine wooden dowel, as described previously [Yun, Y. K., H. K. Kim, J. R. Kim, K. Hwang & Y. J. Ahn. 2012. Contact and fumigant toxicity of Armoracia rusticana essential oil, allyl isothiocyanate and related compounds to Dermatophagoides farinae. Pest Manag. Sci. 68: 788794]. All bioassays were replicated three times using 40-50 adults per replicate.

Plant essential oils and their steam distillates, confirmed to have acaricidal activity against Dermatophagoides farina in the above experiments, are summarized in Table 1 below.

TABLE 1
Acaricidal activities of plant essential oils against
Dermatophagoides farina, measured using a vapor-phase
mortality bioassay duringa 24 h exposure

| | | Mortality % |
|---|---|---|
| | Concentration | (standard |
| Essential oil | (mg/cm²) | error) |
| Basil (Ocimum basilicum) | 0.35 | 100 |
| Cade (Juniperus oxycedrus) | 0.35 | 90 ± 1.3 |
| Caraway (Carum carvi) | 0.35 | 98 ± 1.7 |
| Carrot seed (Daucus carota) | 0.35 | 100 |
| Catnip (Nepeta cataria) | 0.35 | 84 ± 2.9 |
| Cedar (Thuja occidentalis) | 0.35 | 100 |
| Celery (Apium graveolens) | 0.35 | 100 |
| Coriander herb (Coriandrum sativum) | 0.35 | 95 ± 4.6 |
| Cypress (Cupressus sempervirens) | 0.35 | 100 |
| Lemon eucalyptus (Eucalyptus citriodora) | 0.35 | 100 |
| Garlic (Allium sativum) | 0.35 | 100 |
| Juniperberry (Juniperus communis) | 0.35 | 95 ± 5.8 |
| Lime (Citrus aurantifolia) | 0.35 | 92 ± 1.2 |
| Mandarin (Citrus reticulata) | 0.35 | 100 |
| Oregano (Origanum vulgare) | 0.35 | 100 |
| Palmarosa (Cymbopogon martinii) | 0.35 | 100 |
| Pennyroyal (Mentha pulegium) | 0.35 | 100 |
| Pine (Pinus sylvestris) | 0.35 | 100 |
| Dalmatian sage (Salvia officinalis) | 0.35 | 94 ± 2.3 |
| Spearmint (Mentha spicata) | 0.35 | 100 |
| Summer savory (Satureja hortensis) | 0.35 | 100 |

### EXPERIMENTAL EXAMPLE 2

### Acaricidal Activity of Binary Mixtures of Essential Oils against House Dust Mites

The acaricidal activity of binary mixtures of plant essential oils or steam distillates against Dermatophagoides farina was evaluated using a vapor-phase mortality assay (0.17 mg/cm²).

TABLE 2

| Essential oil or | Concentration | Mortality (%, |
|---|---|---|
| essential oil mixture | or mixing ratio | standard error) |
| Spearmint | 0.17 mg/cm² | 100 |
| Oregano | 0.17 mg/cm² | 100 |
| Palmarosa | 0.17 mg/cm² | 99 ± 4.6 |
| Pennyroyal | 0.17 mg/cm² | 98 ± 2.9 |
| Carrot seed | 0.17 mg/cm² | 100 |
| Summer savory | 0.17 mg/cm² | 95 ± 1.7 |
| Spearmint + Oregano | 1:1 | 100 |
| | 2:1 | 100 |
| | 1:2 | 100 |
| Spearmint + Palmarosa | 1:1 | 100 |
| | 2:1 | 100 |
| | 1:2 | 100 |
| Spearmint + Pennyroyal | 1:1 | 100 |
| | 2:1 | 100 |
| | 1:2 | 100 |
| Spearmint + carrot seed | 1:1 | 100 |
| | 2:1 | 100 |
| | 1:2 | 100 |
| Spearmint + Summer | 1:1 | 100 |
| savory | 2:1 | 100 |
| | 1:2 | 100 |
| Carrot seed + Oregano | 1:1 | 100 |
| | 2:1 | 100 |
| | 1:2 | 100 |
| Carrot seed + Palmarosa | 1:1 | 100 |
| | 2:1 | 100 |
| | 1:2 | 100 |
| Carrot seed + Pennyroyal | 1:1 | 100 |
| | 2:1 | 100 |
| | 1:2 | 100 |
| Carrot seed + Summer | 1:1 | 100 |
| savory | 2:1 | 100 |
| | 1:2 | 100 |
| Summer savory + | 1:1 | 100 |
| Oregano | 2:1 | 100 |
| | 1:2 | 100 |
| Summer savory + | 1:1 | 100 |
| Palmarosa | 2:1 | 100 |
| | 1:2 | 100 |
| Summer savory + | 1:1 | 100 |
| Pennyroyal | 2:1 | 100 |
| | 1:2 | 100 |
| Oregano + Palmarosa | 1:1 | 100 |
| | 2:1 | 100 |
| | 1:2 | 100 |
| Oregano + Pennyroyal | 1:1 | 100 |
| | 2:1 | 100 |
| | 1:2 | 100 |
| Palmarosa + Pennyroyal | 1:1 | 100 |
| | 2:1 | 100 |
| | 1:2 | 100 |

### EXPERIMENTAL EXAMPLE 3

### Acaricidal Activity of Formulations against House Dust Mites

The acaricidal effect of each of carrot seed essential formulations and spearmint essential oil formulations, dissolved in ethanolpolyoxyethylene+polyoxypropylene (9:1) styrenated phenyl ether, was evaluated using a spray bioassay.

The results of the evaluation are shown in Tables 3 and 4 below.

In brief, a spray bioassay was used to evaluate the efficacy of four experimental spray formulations against adult American house dust mites (Dermatophagoides farina) [Lee, J. H., J. R. Kim, Y. R. Koh & Y. J. Ahn. 2013. Contact and fumigant toxicity of Pinus densiflora needle hydrodistillate constituents and related compounds and efficacy of spray formulations containing the oil to Dermatophagoides farinae. Pest Manag. Sci. 69: 696702]. Each test solution was sprayed two times successively at 10 cm upwards onto the 5 cm diameter black cotton-fabric circle. After drying for 5 min, each fabric circle was placed onto the bottom section of a disposable Petri dish (5 cm diameter×1 cm height). Groups of 40-50 adult mites (both sexes, 7-10 days old) were placed separately onto the treated fabric circles, and each dish was sealed with the original tight-fitting lid. 2.5 g/L of the commercial acaricide d-phenothrin or permethnrin (cis:trans, 25:75) spray served as a positive control. A negative control consisted of a solution of ethanol-polyoxyethylene+polyoxypropylene (9:1) styrenated phenyl ether in distilled water or water. Mortalities were determined 24 h post-treatment under a dissecting microscope (×20). A mite was considered dead if its body and appendages did not move when prodded with a fine wooden dowel, as described previously [Yun, Y. K., H. K. Kim, J. R. Kim, K. Hwang & Y. J. Ahn. 2012. Contact and fumigant toxicity of Armoracia rusticana essential oil, allyl isothiocyanate and related compounds to Dermatophagoides farinae. Pest Manag. Sci. 68: 788794.]. Each treatment was replicated three times using 40-50 adults per replicate.

The acaricidal activities of carrot seed essential oil formulations and spearmint essential oil formulations against Dermatophagoides farina are shown in Tables 5 and 6 below, respectively.

TABLE 3

| | Content (%) | | | |
|---|---|---|---|---|
| Spray | Carrot seed | | | Distilled |
| formulation | essential oil | Surfactant ¹⁾ | Ethanol | water |
| Carrot seed | 0.5 | 2 | 5 | 92.5 |
| essential | | | | |
| oil-5²⁾ | | | | |
| Carrot seed | 1 | 2 | 5 | 92 |
| essential | | | | |
| oil-10²⁾ | | | | |
| Carrot seed | 2 | 2 | 5 | 91 |
| essential | | | | |
| oil-20²⁾ | | | | |
| Carrot seed | 3 | 2 | 5 | 90 |
| essential | | | | |
| oil-30²⁾ | | | | |

¹⁾ Polyoxyethylene + polyoxypropylene (9:1) styrenated phenyl ether.
²⁾5, 10, 20 and 30 g/L of carrot seed essential oil.

TABLE 4

| | Content (%) | | | |
|---|---|---|---|---|
| Spray | Spearmint seed | | | Distilled |
| formulation | essential oil | Surfactant ¹⁾ | Ethanol | water |
| Spearmint | 1 | 3 | 5 | 91 |
| essential | | | | |
| oil-1²⁾ | | | | |
| Spearmint | 2 | 3 | 5 | 90 |
| essential | | | | |
| oil2²⁾ | | | | |
| Spearmint | 3 | 3 | 5 | 89 |
| essential | | | | |
| oil-3²⁾ | | | | |
| Spearmint | 4 | 3 | 5 | 88 |
| essential | | | | |
| oil-4²⁾ | | | | |

¹⁾ Polyoxyethylene + polyoxypropylene (9:1) styrenated phenyl ether.
²⁾1, 2, 3 and 4% spearmint essential oils.

TABLE 5

| | Mortality (%, |
|---|---|
| Spray formulation | standard error)¹⁾ |
| Carrot seed essential oil-5 | 78 ± 5.8 c |
| Carrot seed essential oil-10 | 92 ± 5.8 b |
| Carrot seed essential oil-20 | 100 a |
| Carrot seed essential oil-30 | 100 a |
| d-Phenothrin | 8.3 ± 1.7 d |

¹⁾P = 0.05 (Bonferroni method).

TABLE 6

| | Mortality (%, |
|---|---|
| Spray formulation | standard error)¹⁾ |
| Spearmint essential oil-1 | 33 ± 3.3 c |
| Spearmint essential oil-2 | 73 ± 5.8 b |
| Spearmint essential oil-3 | 97 ± 3.3 a |
| Spearmint essential oil-4 | 100 a |
| 2.5 g/L of Permethrin) | 17.3 ± 3.3 d |
| (cis:trans, 25:75) | |

¹⁾P = 0.05 (Bonferroni method).

### EXPERIMENTAL EXAMPLE 4

### Neutralizing Activity of Plant Extracts against House Dust Mite Proteins

Adult mites (both sexes, 6-8 days old) were extracted, as described previously [Nakada, S., K. Ito, C. Urata, Y. Sakamoto, M. Hasegawa, T. Nakagawa & T. Miyamoto. 1985. Allergenecity and immunogenicity of house-dust mite (Dermatophagoides farinae) antigens treated with glutaraldehyde. Ann. Allergy 54: 437441; Tovey, E. R. & B. A. Baldo. 1987. Comparison by electroblotting of IgE-binding components in ectracts of house dust mite bodies and spent mite culture. J. Allergy Clin. Immunol. 79: 93102.]. In brief, whole bodies (80 mg fresh weight/4 mL buffer) were homogenized on ice in 0.01 M phosphate-buffered saline (PBS) (pH 7.4) for 15 min. The homogenate was then stirred at 0° C. for 1 hr, centrifuged for 30 min at 14000 g, and concentrated by ultrafiltration to 1 mg/mL of protein.

The protein content was determined using a Bradford protein assay kit (Pierce, Rockford, Ill.). Bovine serum albumin (Pierce, Rockford, Ill.) was used as the standard. Precision Plus Protein Standards was supplied by Bio-Rad (Hercules, Calif.).

SDS-PAGE was performed according to the modified method of Laemmli [Laemmli, U.K. 1970. Cleavage of structural proteins during the assembly of the head of bacteriophage T4. Nature 227: 680685]. Based on the preliminary test results, mixtures of mite proteins (20 mg) and each test material (100, 250, and 500 mg) in 4.5 μL of dimethyl sulfoxide (DMSO) were incubated for 1 hr at 25±1° C. Negative controls consisted of 4.5 μL of DMSO. Tannic acid or 3% tannic acid solution served as a positive control and was similarly formulated. Samples were mixed with an equal volume of SDS sample buffer (4% SDS, 4% mercaptoethanol, and 100 mM Tris-HCl, pH 8.0), boiled for 10 min, and resolved by electrophoresis on 12% (w/v) polyacrylamide gels by using a Mini-Protean 3 electrophoresis cell (Bio-Rad, Hercules, Calif.). After electrophoresis at 120 V for 80 min, the gels were stained with 0.1% Coomassie brilliant blue R-250 for quantification. The intensity of denaturing activity of each test material toward the two major HDM allergens group 1 and 2 was determined using a Gel Doc XR image analyzer with Quantity One Software (Bio-Rad, Hercules, Calif.) according to the manufacturer's instructions.

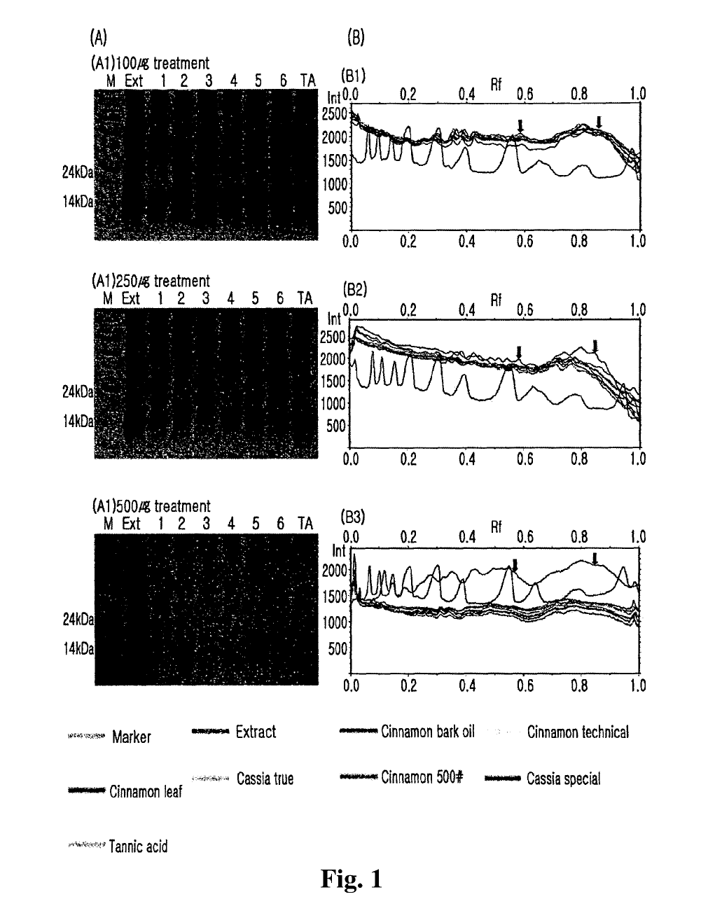

FIG. 1 shows the results of the gel electrophoresis performed as described above. In FIG. 1, lane M represents a protein marker; land Ext represents a negative control loaded only with untreated house dust mite protein; lanes 5 and 6 indicate moderate activity; lanes 1, 2, 3 and 4 indicate strong activity; and lane TA represents a positive control treated with tannic acid.

Plant essential oils and compounds, confirmed to have neutralizing activity against house dust mites in the above experiments, are summarized in Tables 7 and 8 below, respectively.

TABLE 7
Neutralizing activity

| Essential oil | Activity¹⁾ |
|---|---|
| Spearmint | +++ |
| Basil | +++ |
| Cade | +++ |
| Caraway | ++ |
| Carrot | +++ |
| Catnip | ++ |
| Cedar | +++ |
| Celery | ++ |
| Coriander | ++ |
| Cypress | +++ |
| Lemon | +++ |
| Eucalyptus | |
| Garlic | ++ |
| Juniperberry | ++ |
| Lime | ++ |
| Mandarin | ++ |
| Oregano | +++ |
| Palmarosa | ++ |
| Pennyroyal | ++ |
| Pine | +++ |
| Dalmatian Sage | ++ |
| Summer Savory | +++ |

¹⁾+++: comparable to or higher than the activity of the positive control tannic acid;
++: neutralizing activity somewhat lower than that of the positive control.

TABLE 8
Neutralizing activity

| Compound | Activity ^{a} |
|---|---|
| Allyl isothiocyanate | +++ |
| Anethole | ++ |
| Beta-asarone | ++ |
| Camphor | ++ |
| Delta-3-carene | +++ |
| Citronellol | ++ |
| Cuminaldehyde | +++ |
| Cumene | ++ |
| Geranial | +++ |
| Isopulegol | ++ |
| Lavandulol | ++ |
| Linalool oxide | ++ |
| Myristicin | +++ |
| Neral | ++ |
| Nerol | ++ |
| Nerolidol | ++ |
| Thymol | +++ |
| Perillaldehyde | +++ |
| Perilla alcohol | ++ |

^{a} +++: comparable to or higher than the activity of the positive control tannic acid; ++: neutralizing activity somewhat lower than that of the positive control.

In addition, a dot-blot immunoassay for human-specific IgE reactivity was performed, as described previously [Tsai, L. C., Y. C. Sun, P. L. Chao, M. W. Hung, I. C. Kuo, et al. 2000. Protein sequence analysis and mapping of IgE and IgG epitopes of an allergenic 98 kDa Dermatophagoides farinae paramyosin, Der f 11. Allergy 55: 141147]. House dust mite proteins (10 μg) were applied to a PVDF membrane using a Hybri-Dot Manifold (Life Technologies, Gaithersburg, Md.) according to the manufacturer's instructions. After blocking with 0.1% PBS-T containing 5% skim milk, the membrane was incubated with 1:500 diluted allergic patient's antiserum at 4° C. overnight. After washing with 0.1% PBS-T three times, the membrane was incubated with 1:20000 diluted goat anti-human IgG (H+L)-HRP and IgE-HRP conjugate (Zymed Laboratories, Sanfrancisco, Calif.) for 1 hr at 25±1° C. The essential oils and compounds (500 μg each) were tested with the patient's serum which was diluted 1:250, and then incubated 1:5000 diluted IgE-HRP conjugate antibodies. After additional washing, as stated previously, the blot was incubated with ECL chemiluminescence reagent for 1 min and exposed to X-ray films for 5-20 min at room temperature. The intensity of the IgE-reacting dot was determined using a Bio-Rad Gel Doc XR image analyzer, as stated previously. Tannic acid served as a standard reference and was similarly formulated.

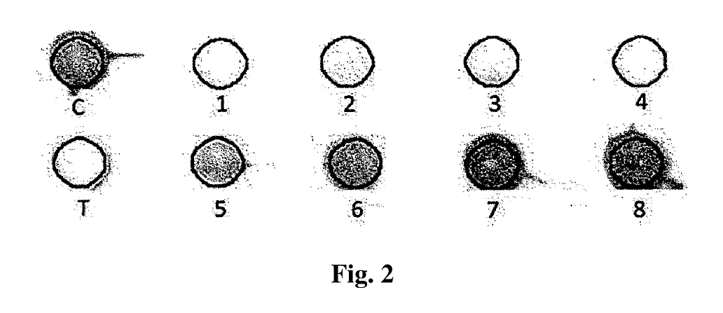

The results of the dot-blot immunoassay performed as described above are shown in FIG. 2. The reference numerals used in FIG. 2 indicate the following: C: untreated control; T: tannic acid; 1: spearmint essential oil; 2: Summer savory essential oil; 3: Oregano essential oil; 4: Carrot seed essential oil; 5: Catnip essential oil; 6: Mandarin essential oil; 7: Lime essential oil; and 8: Celery essential oil.

The inhibitory activities of the above-described plant essential oils and compounds against the allergenicity of two species of house dust mite proteins are shown in Tables 9 and 10 below, respectively.

TABLE 9

Inhibition of allergenicity

| | Dermatophagoides | Dermatophagoides |
|---|---|---|
| Essential oil | farina | pteronyssinus |
| Basil | 72.6 | 75.7 |
| Cade | 71.5 | 75.1 |
| Caraway | 64.6 | 68.7 |
| Carrot | 72.4 | 62.2 |
| Catnip | 61.1 | 53.3 |
| Cedar | 67.4 | 66.5 |
| Celery | 59.7 | 52.8 |
| Coriander | 61.5 | 56.4 |
| Cypress | 75.4 | 67.2 |
| Lemon Eucalyptus | 68.6 | 74.2 |
| Garlic | 66.5 | 56.4 |
| Juniperberry | 67.7 | 58.4 |
| Lime | 48.3 | 69.2 |
| Mandarin | 57.6 | 65.3 |
| Oregano | 76.5 | 62.4 |
| Palmarosa | 67.5 | 62.9 |
| Pennyroyal | 71.3 | 57.0 |
| Pine | 68.9 | 71.7 |
| Dalmatian sage | 57.8 | 48.9 |
| Summer savory | 75.1 | 74.7 |
| Spearmint | 78.4 | 80.3 |
| Tannic acid | 87.2 | 81.1 |

TABLE 10

Inhibition of allergenicity

| | Dermatophagoides | Dermatophagoides |
|---|---|---|
| Compound | farina | pteronyssinus |
| Allyl isothiocyanate | 82.1 | 73.0 |
| Anethole | 62.3 | 52.1 |
| Beta-asarone | 64.9 | 68.5 |
| Camphor | 78.2 | 77.9 |
| Delta-3-carene | 77.9 | 78.1 |
| Citronellol | 61.2 | 49.2 |
| Cuminaldehyde | 80.4 | 76.1 |
| Cumene | 60.9 | 47.8 |
| Geranial | 72.6 | 68.1 |
| Isopulegol | 76.5 | 57.4 |
| Lavandulol | 74.4 | 62.7 |
| Linalool oxide | 61.5 | 66.2 |
| Myristicin | 76.3 | 67.0 |
| Neral | 77.2 | 56.5 |
| Nerol | 67.9 | 42.3 |
| Nerolidol | 42.3 | 67.7 |
| Perillaldehyde | 79.1 | 76.4 |
| Perilla alcohol | 68.7 | 56.5 |
| Thymol | 79.4 | 67.9 |

### EXPERIMENTAL EXAMPLE 5

### Neutralizing Activity of Mixtures of Cassia or Cinnamon Essential Oil and Other Essential Oils Against House Dust Mite Proteins

Cassia or Cinnamon essential oil and other essential oils were mixed at a ratio of 2:1. According to the method of Experimental Example 4, the neutralizing activity of the mixtures was measured, and the results of the measurement are shown in Table 11 below.

TABLE 11

| | Inhibition of allergenicity | |
|---|---|---|
| | Dermatophagoides | Dermatophagoides |
| Essential oil mixture | farina | pteronyssinus |
| Cinnamon + Oregano | 85.2 | 79.6 |
| Cinnamon + Palmarosa | 76.3 | 70.1 |
| Cinnamon + carrot seed | 82.5 | 74.7 |
| Cinnamon + Summer savory | 74.4 | 78.8 |
| Cassia + Oregano | 86.9 | 78.7 |
| Cassia + Palmarosa | 79.7 | 76.4 |
| Cassia + carrot seed | 82.3 | 79.5 |
| Cassia + Summer savory | 80.7 | 79.8 |

As described above, the inactivator for denaturating or neutralizing house dust mite allergen proteins and the composition comprising the same according to the present invention can be effectively used for the prevention, alleviation, mitigation or treatment of various allergic diseases that can be caused by allergens derived from house dust mites. In addition, the inactivator and the composition can significantly reduce the prevalence of diseases caused by house dust mites, and can also significantly reduce the frequency of exposure of people to house dust mites.

1. An inactivator for house dust mite allergen proteins, which has an ability to denature or neutralize house dust mite allergen proteins, the inactivator being composed of at least one compound selected from the group consisting of allyl isothiocyanate, anethole, beta-asarone, camphor, delta-3-carene, citronellol, cumene, cuminaldehyde, geranial, isopulegol, lavandulol, linalool oxide, myristicin, neral, nerol, nerolidol, perillaldehyde, perilla alcohol, and thymol.

2. An inactivator for house dust mite allergen proteins, which has an ability to denature or neutralize house dust mite allergen proteins, the inactivator being composed of either an essential oil or a steam distillate from at least one plant selected from the group consisting of basil (Ocimum basilicum), cade (Juniperus oxycedrus), caraway (Carum carni), carrot seed (Daucus carota), catnip (Nepeta cataria), celery (Apium graveolens), coriander herb (Coriandrum sativum), cypress (Cupressus sempervirens), lemon eucalyptus (Eucalyptus citriodora), garlic (Allium sativum), juniperberry (Juniperus communis), lime (Citrus aurantifolia), mandarin (Citrus reticulata), oregano (Origanum vulgare), palmarosa (Cymbopogon martinii), pennyroyal (Mentha pulegium), pine (Pinus sylvestris), Dalmatian sage (Salvia officinalis), spearmint (Mentha spicata), and summer savory (Satureja hortensis).

3. The inactivator for house dust mite allergen proteins according to claim 2, wherein the inactivator is composed of a mixture of the plant essential oil and the steam distillate.

4. A composition for inactivating house dust mite allergen proteins or killing house dust mites, the composition comprising an effective amount of an activator for denaturating or neutralizing house dust mite allergens proteins, the inactivator being composed of either an essential oil or a steam distillate from at least one plant selected from the group consisting of basil (Ocimum basilicum), cade (Juniperus oxycedrus), caraway (Carum carvi), carrot seed (Daucus carota), catnip (Nepeta cataria), celery (Apium graveolens), coriander herb (Coriandrum sativum), cypress (Cupressus sempervirens), lemon eucalyptus (Eucalyptus citriodora), garlic (Allium sativum), juniperberry (Juniperus communis), lime (Citrus aurantifolia), mandarin (Citrus reticulata), oregano (Origanum vulgare), palmarosa (Cymbopogon martinii), pennyroyal (Mentha pulegium), pine (Pinus sylvestris), Dalmatian sage (Salvia officinalis), spearmint (Mentha spicata), and summer savory (Satureja hortensis).

5. The composition of claim 4, wherein the effective amount is 0.1-50 wt % based on the total weight of the composition.

6. The composition of claim 5, wherein the effective amount is 0.1-10 wt % based on the total weight of the composition.

7. The composition of claim 6, further comprising at least one additive selected from the group consisting of tannic acid, pesticides, acaricides, and aromatics.

8. The composition of claim 4, further comprising ethanol as a solvent, polyoxyethylene+polyoxypropylene (9:1) styrenated phenyl ether as a surfactant, and distilled water.

9. The composition of claim 4, further comprising polyoxyethylene lauryl ether, polysorbate 80, ethanol as a solvent, and distilled water.

10. The composition of claim 4, which is in the form of aerosol, spray, solution, solution, suspension, powder, or capsule.

11. (canceled)
